(19) United States
(12) Patent Application Publication
(10) Pub. No.: US 2009/0240400 A1
(43) Pub. Date: Sep. 24, 2009

(54) Vehicle Security Control System

(75) Inventors: Denis Lachapelle, Legardeur (CA); Mario Fournelle, St-Jerome (CA); Alain Belanger, Montreal (CA)

Correspondence Address: GORDON & JACOBSON, P.C., 60 LONG RIDGE ROAD, SUITE 407, STAMFORD, CT, 06902, US

(73) Assignee: CAR-GLASS-LUXEMBOURG SARL - ZUG BRANCH, Zug (CH)

(21) Appl. No.: 12/282,445

(22) PCT Filed: Mar. 8, 2007
(86) PCT No.: PCT/EP2007/002003

§ 371 Date: Jun. 16, 2009

(30) Foreign Application Priority Data
Mar. 11, 2006 (GB) 0604971.2

(51) Int. Cl. B60R 25/10

(52) U.S. Cl. 701/45; 701/36

(57) ABSTRACT

A vehicle security system for controlling the operation of a vehicle. The security system includes a controller and a concealed proximity sensor that provides an input to the controller. The proximity sensor is activated by the presence of a body within a defined detection zone in the interior of the vehicle. The controller receives additional inputs from additional devices and toggles through a plurality of security states in which different levels of activation and immobilization are triggered depending upon user input and upon the specific inputs received.

### 1. FIELD OF THE INVENTION

The present invention relates to a vehicle security control system.

### 2. STATE OF THE ART

Vehicle security control systems are known such as alarm systems that produce audible and visible output if vehicle security is breached. Vehicle immobilisers are also known, such as those that inhibit ignition of a vehicle if a required protocol is not followed or a required transponder key signal is not detected. Various arrangements permitting valet operation are also known.

### SUMMARY OF THE INVENTION

An improved arrangement has now been devised.

According to a first aspect, the present invention provides a vehicle security control system for controlling operation of a vehicle system, the control system including:
a controller for controlling the operation of the vehicle system;
a proximity sensor device providing an input into the controller.

The vehicle system controlled may be a security system such as an alarm system and/or an immobiliser system. The vehicle system controlled may therefore include the vehicle ignition system or an engine management system.

The proximity sensor is conveniently arranged to be concealed from view in the vehicle, preferably being secreted behind a vehicle dash, facia, trim or panel of the vehicle.

It is preferred that the proximity sensor device is a non-contact device, preferably activated by the presence of a body within a defined detection zone, in the interior of the vehicle cabin.

Beneficially, the defined detection zone extends only a small distance (preferably to substantially 20 mm or less) from the proximity sensor device. More preferably, the defined detection zone extends to substantially 10 mm or less from the proximity sensor device.

It is preferred that the proximity sensor device is required to detect the presence of a body for a predetermined period in order to provide an input that triggers a change in the state of the control system. This reduces the risk of unintentional activation of the system via the proximity sensor device. Beneficially, the predetermined period is 5 s or more, more preferably 10 s or more.

In certain embodiments the proximity sensor device may comprises a radiofrequency (or radar) transceiver device. Other non-contact proximity sensor devices may be used such as, for example, ultrasonic transceiver devices or eddy current detector devices.

Beneficially, the system includes a vehicle brake an input to the controller.

Desirably, the system includes a vehicle speed input to the controller.

The system preferably includes a vehicle ignition input to the controller.

The controller operation of the vehicle system is preferably dependent upon a system state of the vehicle system and/or the control system. For example the controller operation at vehicle start up may be dependent upon the state of the control system at the point at which the vehicle was previously shut down.

It is preferred that the controller operation of the vehicle system is dependent upon:
i) a system state of the vehicle system and/or the control system; and
ii) whether a control input is received from the proximity sensor device.

The controller operation of the vehicle system is beneficially dependent upon previous system state of the vehicle system and/or the control system.

The controller is preferably operational to control the vehicle system in one of a plurality of control states dependent upon:
i) a system state of the vehicle system and/or the control system; and
ii) whether a control input is received from the proximity sensor device.

Beneficially, one of the plurality of control states is a valet state. Advantageously, the valet state is disabled and or enabled by means of activation of the proximity sensor device.

It is preferred that, in valet mode:
i) the vehicle can be driven at reduced function only; and/or
ii) the vehicle can be driven for a predetermined time only.

A system according to the invention may operate such that, at an input into the controller (for example at vehicle start up) the controller determines the state of the control system and/or the vehicle system, and whether input into the controller from the proximity sensor device is needed.

Preferably, the system operates such that, if one or more expected inputs into the controller are not provided from the proximity sensor device, then an alarm or disablement state is triggered. For example the system may open the immobilisation circuit preventing the vehicle from running, and/or trigger an alarm system (such as an audible and/or visible alarm).

Beneficially the system proceeds through a plurality of security states, preferably of increasing security. The system preferably operates such that a predetermined input (via the proximity sensor device) is expected in the relevant states, the system progressing from one state to another increased security state, if required input is not received.

In the system of the invention, the controller operates to follow a control algorithm in order to determine the control state of operation of the vehicle system.

According to a further aspect, the present invention provides a vehicle security control system for controlling operation of a vehicle system, the control system including:

a controller for controlling the operation of the vehicle system;

a secreted input device for input to the controller, the input device enabling toggling of a valet state of the control system between a valet active state and a valet inactive state, wherein in addition to the input from the secreted input device, the toggling is dependent upon the state in which the control system rests and whether control inputs are received from one or more devices other than the secreted input device.

According to a further aspect, the invention provides a method of controlling a vehicle system, the method comprising using an output from a vehicle secreted device for input to the controller, the input device enabling toggling of a valet state of the control system between a valet active state and a valet inactive state, wherein in addition to the input from the secreted input device, the toggling is dependent upon the state in which the control system rests and whether control inputs are received from one or more devices other than the secreted input device.

As mentioned previously, the secreted input device is preferably a non-contact proximity sensor device.

According to a further aspect, the invention provides a vehicle security control system for controlling operation of a vehicle system, the control system including:

a controller for controlling the operation of the vehicle system;

an input device for input to the controller:

wherein the system is capable of proceeding through a plurality of security states, of increasing security, a predetermined input via the input device being expected in the relevant states, the system progressing from one state to another increased security state, if required input is not received.

The preferred features described in relation to the first aspect of the invention, may also be preferred for the other aspects of the invention.

The invention will now be further described, by way of example only, and with reference to the accompanying drawings.

### BRIEF DESCRIPTION OF THE DRAWINGS

FIG. 1 is a schematic diagram of a vehicle security control system for controlling operation of a vehicle system, in accordance with the invention.

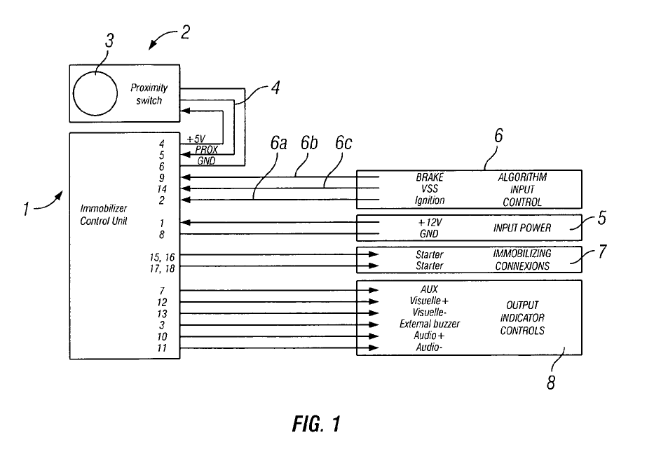

FIG. 2 is a firs part of a flow diagram depicting operation of the system of the invention; and

FIG. 3 is a continuation of the flow diagram of figure

### BRIEF DESCRIPTION OF THE PREFERRED EMBODIMENT

Referring to the drawings the vehicle security control system comprises a micro-controller unit 1 which is typically mounted behind the dash facia of the vehicle, so as not to be readily accessible. Connected to the micro-controller unit 1 is a proximity switch device 2, which is mounted to be concealed, for example behind the dash facia or a door panel in a location known only to the owner of the vehicle (and the technician that has fitted the system). To all intent and purpose the presence of the system in the vehicle and the precise location of the proximity sensor device 2 is unknown to all except the owner. The proximity sensor device 2 comprises a radiofrequency transceiver 3 mounted in an epoxy container. The transceiver is arranged to emit a RF signal that attenuates such that a reflected signal is only registered if a reflecting object is placed within a zone 20 mm or less (more preferably 10 mm or less) from the device 2. Other potential devices could be used in place of the radar transceiver proximity sensor device 2, such as for example an utrasound transceiver device, a capacitive proximity sensor device or an eddy current proximity sensor device. The proximity sensor device 2 provides input to the micro-controller unit 1 via the cable connection 4.

Power input to the controller is provided from a 12 v power supply 5 such as a vehicle battery. Vehicle system inputs are provided in accordance with requirements from the algorithm to which the micro-controller unit 1 operates. These are shown at block 6 and can comprise a vehicle ignition input 6a, a vehicle brake input 6b and a vehicle speed sensor input 6c. Outputs from the micro-controller unit 1 are to a vehicle immobiliser circuit 7, and to an alarm system 8. The alarm system 8 is a visual and audible alarm system in the embodiment described.

The aim of the system of the invention is to provide a level of security, typically in addition to a primary level such as a transponder key activated immobiliser system fitted to the vehicle. The system utilises the proximity sensor device 2 to control operation in combination with standard user inputs such that if a predetermined protocol is not followed then, the vehicle immobiliser is activated and also an audible and/or visual alarm sounds to ward off the unauthorised user. The protocol used determines the state of the control system or the vehicle system (ignition, immobiliser etc) previously extant in order to determine the appropriate response to an input command. The system for example can be used to conveniently toggle and control a valet state. In the valet state the user can operate the vehicle without risk of the alarm system 8 being activated, even though the valet driver is not aware of the presence of the security control system or the location of the proximity sensor device 2. In some instances valet mode only permits the vehicle operation at reduced function (for example at low speed).

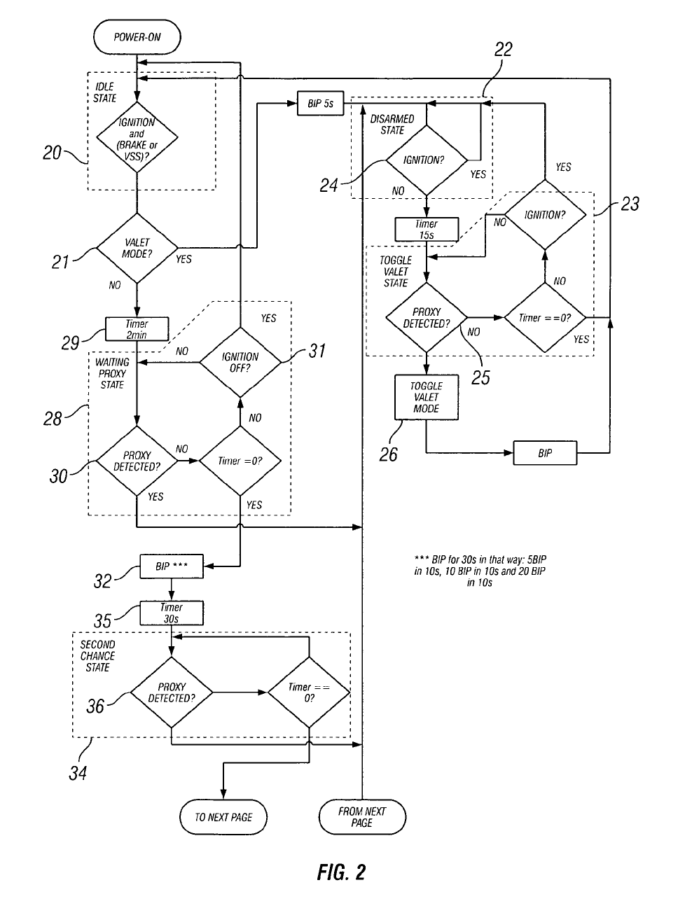

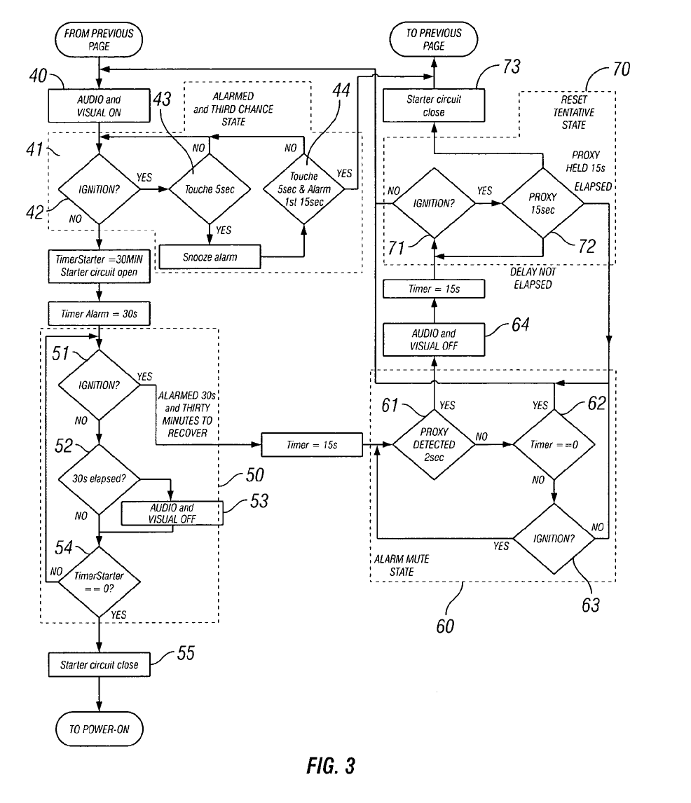

An exemplary operation protocol for a system in accordance with the invention will now be described with reference the flow diagram of FIGS. 2 and 3.

Assuming a scenario in which the vehicle has been used normally and is now parked with the ignition off. The control system is then in idle state 20 waiting for a start input such as ‘ignition’, ‘ignition and brake’ or ‘vehicle speed sensor’ (VSS) input, indicating to the control system that the vehicle is at start up. At block 21, the system determines whether the valet mode was active last time the vehicle was in use. If the control system determines that the valet state was active the last time the vehicle was running, an audible beep stream is emitted by the alarm system 8 and the system goes to the disarmed state (routine 22) whilst the vehicle is running. This permits valet return of the vehicle. At turn of off of the ignition the control algorithm directs the control system to the ‘toggle valet’ state (routine 23) allowing the driver to change the activity state (remove the valet mode) provided the proximity sensor device is activated for the required period (15 s in this instance). The proximity sensor device 2 is activated by the user placing a hand or other body in the detection zone adjacent the non contact proximity sensor device 2. At block 24 the ignition state is determined. At block 25 the proximity sensor device signal detection is determined, in order to run the ‘toggle valet mode’ operation at 26.

Alternatively, if at start up 20 the system determines that valet mode was not active, then the algorithm directs the system to follow a ‘waiting proxy state’ at routine 28. This includes a time delay 29 of 2 minutes in which the authorised user (knowing the location of the hidden proximity sensor device 2) can ensure the system goes to the ‘disarmed state’ 22, again by means of placing an object (eg a hand) in the detection zone of the proximity sensor device 2. If alternatively, during the 2 minute time delay, the ignition goes back to off, then the control algorithm causes the system to return to the ‘idle state’ 20 initial condition. In routine 28, detection by the proximity sensor device 2 is determined at block 30, and the ignition state of the vehicle is determined at 31.

If, as a further alternative, the 2 minute delay period expires without the ignition being turned off or the proximity sensor device 2 being activated, then a distinctive audible beep stream is emitted 32 and the control algorithm directs the system to a ‘second chance’ state with the aim of giving an authorised user a further opportunity to activate the proximity sensor device 2 within a further period of 30 seconds 35. In routine 34, detection by the proximity sensor device 2 is determined at block 36.

If the proximity sensor device 2 detects the presence of an object at the detection zone within the 30 s ‘second chance’ delay then the algorithm directs the control system to the ‘disarmed state’ 22. If as an alternative the 30 s ‘second chance’ delay expires without the proximity sensor device 2 giving a detection input to the micro-controller unit 1, then the audio and visual indicator of the alarm system 8 are activated (block 40) and the system goes to the ‘alarmed and third chance’ state shown in routine 41.

In ‘alarmed and third chance’ state the driver has the possibility of disarming the system by activating the proximity sensor device 2 for 15 s. After 5 s the audio and visual indicator will turn off; after another 5 seconds of activating the proximity sensor device 2, the algorithm returns the system to the ‘disarmed’ state 22. If alternatively, the ignition is turned off without the proximity sensor device 2 being activated, then the starter immobilising connections 7 will be opened (preventing the vehicle from being subsequently started for 30 minutes) in this event the algorithm directs the system to the ‘alarmed and thirty minutes to recover’ state (routine 50). In routine 41, the ignition status determination is made at block 42 and the proximity sensor device detector output determined in blocks 43 and 44.

In the ‘alarmed and thirty minutes to recover’ state (routine 50), for the next 30 s the audio and visual indicator of the alarm system 8 will remain activated. If the ignition remains off during the 30 minute period, then after expiry of the 30 minute period, the opened starter immobilising connections 7 will be deactivated (enabling the ignition to be activated to start the vehicle). The algorithm then directs the control system to the idle state 20. In routine 50 ignition state is determined at block 51 and the 30 s timer determination at block 52, the audio visual on/off decision being made at block 53. If block 54 determines elapse of the 30 minute period, the routine directs at block 55 to the idle state 20.

Alternatively, if during the thirty minute recovery period the ignition is turned on, then the control system goes to the ‘alarm mute’ state (routine 60). In the ‘alarm mute’ state 60 the audio visual indicator of the alarm system 8 can be de-activated by user intervention to activate the proximity sensor device 2 for 2 s in 15 s. If this occurs the system goes to ‘reset tentative’ state (routine 70). Proximity sensor device 2 detection determination is carried out at block 61, and time elapsed is determined at block 62. Ignition activation is determined at block 63 and audio visual off is effected at block 64.

In ‘reset tentative’ state 70, if the proximity sensor device 2 is activated for 15 s the starter open circuit 7 is de-activated (at block 73) permitting the vehicle to be started, and the algorithm goes to the disarmed state (routine 22). In routine 70, ignition status is determined at block 71 and proximity sensor device activation for the required time is determined at block 72.

The present invention provides a convenient and useful vehicle security control system in which a hidden, non-contact proximity sensor device can be used to control an alarm system and/or operation of another vehicle system such as an ignition system or immobiliser system. The control algorithm provides for a number of cascading control active states in which different levels of alarm activation and vehicle immobilisation are triggered dependent upon how the user interacts with the system. The requirement to activate the proximity sensor device for a required time period (for example between 5 s and 20 s (particularly preferred for 10 s or more) ensures that the chance of accidental input to the control system via the proximity sensor device is ameliorated. It is envisaged that the skilled addressee will readily appreciate that the specific routines of the control algorithm may be varied and indeed certain routines may be omitted without departing from the scope of the invention.

1. A vehicle security control system for controlling operation of a vehicle system, the control system comprising:
a controller for controlling the operation of the vehicle system;
a proximity sensor device for providing an input into the controller.

2. A vehicle security control system according to claim 1, wherein: the proximity sensor device concealed from view in a vehicle.

3. A vehicle security control system according to claim 1, wherein:
the proximity sensor device is concealed behind one of a dash, instrument panel, trim and panel of a vehicle.

4. A vehicle security control system according to claim 1, wherein:
the proximity sensor device is activatable by the presence of a body within a defined detection zone.

5. A vehicle security control system according to claim 4, wherein:
the detection zone is in an interior of a cabin of a vehicle.

6. A vehicle security control system according to claim 4, wherein:
the defined detection zone extends from the proximity sensor device within a range, said range having an upper limit of 20 mm.

7. A vehicle security control system according to claim 4, wherein:
the defined detection zone extends from the proximity sensor within a range, said range having an upper limit of 10 mm.

8. A vehicle security control system according to claim 1, wherein:
the proximity sensor device is required to detect the presence of a body for a predetermined period in order to provide an input that triggers a change in a state of the control system.

9. A vehicle security control system according to claim 8, wherein: the predetermined period is at least 5 seconds.

10. A vehicle security control system according to claim 9, wherein: the predetermined period is at least 10 seconds.

11. A vehicle security control system according to claim 1, wherein:
the proximity sensor device is arranged to detect proximity of a body without contact with the body.

12. A vehicle security control system according to claim 1, wherein:
the proximity sensor device includes a radiofrequency device.

13. A vehicle security control system according to claim 1, wherein:
the security control system includes a vehicle brake input to the controller.

14. A vehicle security control system according to claim 1, wherein:
the security control system includes a vehicle speed input to the controller.

15. A vehicle security control system according to claim 1, wherein:
the security control system includes a vehicle ignition input to the controller.

16. A vehicle security control system according to claim 1, wherein:
operation of the vehicle system by the controller is dependent upon a system state of at least one of the vehicle system and the control system.

17. A vehicle security control system according to claim 16, wherein:
operation of the vehicle system by the controller is dependent upon at least one of a system state of the vehicle system and the control system, and receipt of a control input from the proximity sensor device.

18. A vehicle security control system according to claim 16, wherein:
operation of the vehicle system by the controller is dependent upon at least one of a previous system state of the vehicle system and the control system.

19. A vehicle security control system according to claim 1, wherein:
the controller is operational to control the vehicle system in one of a plurality of control states dependent upon at least one of a system state of the vehicle system and the control system, and dependent upon whether a control input is received from the proximity sensor device.

20. A vehicle security control system according to claim 19, wherein:
one of the plurality of control states is a valet mode.

21. A vehicle security control system according to claim 20, wherein:
the valet mode is disabled and or enabled via actuation of the proximity sensor device.

22. A vehicle security control system according to claim 20 wherein, in valet mode, the vehicle can be driven for a predetermined time only.

23. A vehicle security control system according to claim 20, wherein:
an additional input into the controller determines one of the plurality of control states of at least one of the control system and the vehicle system, and determines whether the control input into the controller from the proximity sensor device is needed.

24. A vehicle security control system according to claim 23, wherein:
if at least one expected input into the controller is not provided from the proximity sensor device, then an alarm state is triggered.

25. A vehicle security control system according to claim 24, wherein:
in the alarm state an audible or visible alarm is triggered.

26. A vehicle security control system according to claim 19, wherein:
the controller operates according to a control algorithm to determine the particular control state of operation of the vehicle system.

27. A vehicle security control system for controlling operation of a vehicle system, the control system comprising:
a controller for controlling the operation of the vehicle system;
a concealed input device for providing an input to the controller, the input device enabling toggling of the control system between a valet active state and a valet inactive state,
wherein, in addition to the input from the concealed input device, the toggling is dependent upon the particular state in which the control system rests, and upon whether at least one additional control input is received from at least one additional device.

28. A vehicle security control system according to claim 27, wherein:
one of the at least one additional device indicates start up of at least one of an engine, brake, or speed sensor of the vehicle.

29. A vehicle security control system according to claim 27, wherein:
the concealed input device is a non-contact proximity sensor device.

30. A method of controlling a vehicle system, the method comprising;
using an output from a concealed device in a vehicle for input to a controller, the device enabling toggling of a control system between a valet active state and a valet inactive state,
wherein, in addition to the input from the concealed device the toggling is dependent upon the particular state in which the control system rests, and whether at least one additional control input is received from at least one device other than the concealed input device.

31. A method according to claim 30, wherein: the concealed device is a non-contact proximity sensor.

32. A vehicle security control system for controlling operation of a vehicle system, the control system: comprising:
a controller for controlling the operation of the vehicle system;
an input device for providing an input to the controller,
wherein, the security control system is capable of proceeding through a plurality of security states having corresponding levels of security,
wherein, in at least one of the security states, a predetermined input via the input device is expected, and
wherein, the system is configured to progress from one of the plurality of security states to another of the plurality of security states having a higher security level if a required input is not received.

33. A vehicle security control system according to claim 32, wherein:
the input device includes a proximity sensor device.
